(19) United States
(12) Patent Application Publication
(10) Pub. No.: US 2010/0318738 A1
(43) Pub. Date: Dec. 16, 2010

(54) HARD DISK SYSTEM AND METHOD FOR ACCESSING THE SAME

(75) Inventor: Yu-Liang SUN, TAIPEI CITY (TW)

Correspondence Address: BRIAN M. MCINNIS, 12th Floor, Ruttonjee House, 11 Duddell Street, Hong Kong, HK

(73) Assignee: INVENTEC CORPORATION, TAIPEI CITY (TW)

(21) Appl. No.: 12/509,498

(22) Filed: Jul. 27, 2009

(30) Foreign Application Priority Data
Jun. 12, 2009 (TW) 98119796

(51) Int. Cl. G06F 12/00

(52) U.S. Cl. 711/114; 711/112; 711/E12.001

(57) ABSTRACT

A hard disk system and a method for accessing the hard disk system are provided. The hard disk system includes a first hard disk and a second hard disk. The first hard disk is used to store system data that is read-only. The second hard disk includes a mapped data storage section and a variable data storage section, wherein the mapped data storage section is used to store a mapped data generated by mapping the system data of the first hard disk. A maximum number of writes for the first hard disk is less than a maximum number of writes for the second hard disk, wherein the hard disk system performs data modification via the variable data section of the second hard disk.

### RELATED APPLICATIONS

This application claims priority to Taiwan Application Serial Number 98119796, filed Jun. 12, 2009, which is herein incorporated by reference.

### BACKGROUND

1. Field of Invention

The present invention relates to a hard disk system. More particularly, the present invention relates to a hard disk system including a plurality of hard disks in which different maximum numbers of writes are allowed respectively.

2. Description of Related Art

A solid state hard disk is a new type of hard disk having the advantages of high speed, energy-saving, low heat generation and great ability to withstand shock and vibration. However, in spite of these advantages, the limited numbed of writes for the solid state hard disk has become a fatal disadvantage to the solid state hard disk. When the solid state hard disk is applied on a server system, since the server system requires a ling-termed data access to large amounts of data, the aforementioned limitation of writes will shorten the operation life of the solid state hard disk very quickly, and thus the solid state hard disk cannot replace a conventional hard disk due to its low efficacy. However, a reading speed of the conventional hard disk is far lower reading than that of the solid state hard disk. Therefore, whether using the solid state hard disk or using the conventional hard disk, both of them have their respective shortcomings and cannot be applied to their best uses.

Hence, how to design a novel hard disk system for performing a high-speed data access without limiting to the number of writes, is an issue desired to be resolved in this industry.

### SUMMARY

Hence, an aspect of the present invention is to provide a hard disk system including a first hard disk and a second hard disk. The first hard disk is 1o used to store system data, wherein the system data is read-only. The second hard disk includes a mapped data storage section and a variable data storage section, wherein the mapped data storage section is used to store mapped data generated by mapping the system data of the first hard disk. A maximum number of writes for the first hard disk is less than that for the second hard disk, and the hard disk system performs data modification via the variable data section of the second hard disk.

Another aspect of the present invention is to provide a method for accessing a hard disk system, wherein the hard disk system includes a first hard disk and a second hard disk, and a maximum number of writes for the first hard disk is less than that for the second hard disk. The method includes the steps of: mapping system data of the first hard disk onto a mapped data storage section of the second hard disk; reading out the system data of the first hard disk; and performing data modification on a variable data storage section of the second hard disk.

The application of the present invention can prolong the operation life of the entire hard disk system by performing data reading on the first hard disk for which the maximum number of writes is less; and performing data modification on the second hard disk for which the maximum number of writes is more, thereby resolving the issue described above.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with-regard to the following description, appended claims, and accompanying drawings where:

FIG. 1 is a schematic diagram showing a hard disk system according to an embodiment of the present invention; and

FIG. 2 is a flow chart showing a method for accessing the hard disk system according to another embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

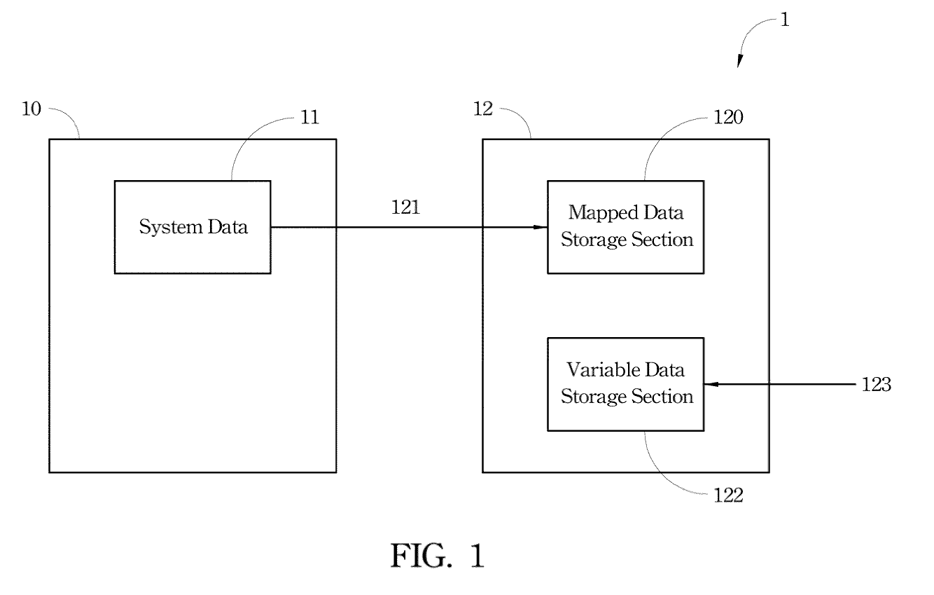

Referring to FIG. 1, FIG. 1 is a schematic diagram showing a hard disk system 1 according to an embodiment of the present invention. The hard disk system 1 includes a first hard disk 10 and a second hard disk 12, wherein the first hard disk 10 is a hard disk for which a maximum number of writes is less but a reading speed is higher, and the second hard disk 12 is a hard disk for which a maximum number of writes is more but a reading speed is lower. In one embodiment, the first hard disk 10 can be one single solid state hard disk, or a solid state RAID (redundant array of independent disks) composed of a plurality of solid state hard disks; and the second hard disk 12 can be one single liquid bearing hard disk, or a RAID composed of a plurality of liquid bearing hard disks. In another embodiment, the first hard disk 10 and the second hard disk 12 may be other types of hard disks, and are not limited to the aforementioned types.

The first hard disk 10 is used for storing system data 11, wherein the system data 11 including data of a kernel operating system or other system information related to the operating system. The system data 11 of the first hard disk 10 is read-only, and thus, for the entire hard disk system 1, the first hard disk 10 is merely used to read the system data 11. On the other hand, the second hard disk 12 includes a mapped data storage section 120 and a variable data storage section 122, wherein the mapped data storage section 20 is used to store mapped data 121 generated by mapping the system data 11 of the first hard disk 10. By using the mapped data 121, the first hard disk 10 and the second hard disk 12 can be linked together. When the hard disk system 10 is desired to perform data modification, the data modification is essentially performed on the variable data storage section 122. For example, if a set of data 123 is newly added to the hard disk system 1, the set of data 123 will be written into the variable data storage section 122, and no writing step will be performed on the first hard disk 10. If the hard disk system 1 is desired to modify the set of data 123 subsequently, only the set of data 123 stored in the variable data storage section 122 will be modified, and no writing step will be performed on the first hard disk 10. Hence, any data modification with respect to the hard disk system 1 is performed on the second hard disk 12, and the first hard disk 11 is merely provided for reading the system data 11.

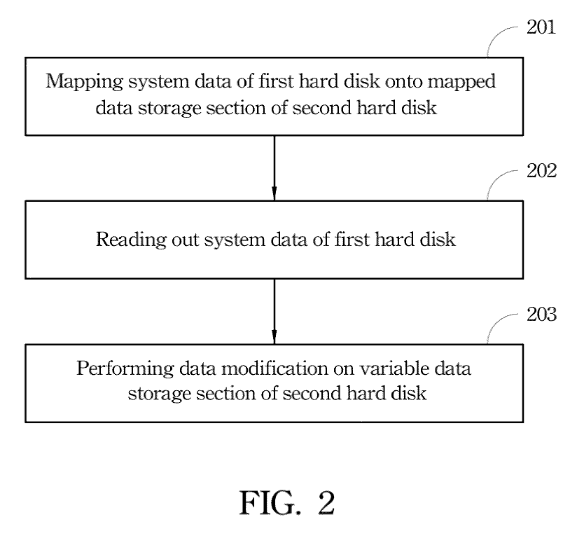

FIG. 2 is a flow chart showing a method for accessing the hard disk system according to another embodiment of the present invention, wherein the hard disk system includes a first hard disk and a second hard disk, and a maximum number of writes for the first hard disk is less than that for the second hard disk. The method for accessing the hard disk system includes the following step. Step 201 is performed for mapping system data of the first hard disk onto a mapped data storage section of the second hard disk, and step 202 is performed for reading out the system data of the first hard disk, and step 203 is performed for performing data modification on a variable data storage section of the second hard disk.

It can be known from the aforementioned embodiments that the present invention can advantageously prolong the operation life of the entire hard disk system by performing data reading on the first hard disk for which the maximum number of writes is less but the reading speed is higher; and performing data modification on the second hard disk for which the maximum number of writes is more but the reading speed is lower.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A hard disk system, comprising:
a first hard disk used to store system data, wherein the system data is read-only;
a second hard disk including a mapped data storage section and a variable data storage section, wherein the mapped data storage section is used to store mapped data generated by mapping the system data of the first hard disk;
wherein a maximum number of writes for the first hard disk is less than that for the second hard disk, and the hard disk system performs data modification via the variable data section of the second hard disk.

2. The hard disk system as claimed in claim 1, wherein the first hard disk is a solid state hard disk.

3. The hard disk system as claimed in claim 1, wherein the first hard disk is a solid state RAID (redundant array of independent disks).

4. The hard disk system as claimed in claim 1, wherein the second hard disk is a liquid bearing hard disk.

5. The hard disk system as claimed in claim 1, wherein the second hard disk is a RAID of liquid bearing hard disks.

6. The hard disk system as claimed in claim 1, wherein the system data comprising data of a kernel operation system.

7. The hard disk system as claimed in claim 1, wherein the first hard disk has a faster reading speed than the second hard disk.

8. A method for accessing a hard disk system, wherein the hard disk system comprises a first hard disk and a second hard disk, and a maximum number of writes for the first hard disk is less than that for the second hard disk, the method comprising:
mapping system data of the first hard disk onto a mapped data storage section of the second hard disk;
reading out the system data of the first hard disk; and
performing data modification on a variable data storage section of the second hard disk.

9. The method as claimed in claim 8, wherein the first hard disk is a solid state hard disk or a solid state RAID, and the second hard disk is a liquid bearing hard disk or a RAID of liquid bearing hard disks.

10. The method as claimed in claim 8, wherein the first hard disk has a faster reading speed than the second hard disk.
